(19) United States
(12) Patent Application Publication
(10) Pub. No.: US 2016/0318607 A1
(43) Pub. Date: Nov. 3, 2016

(54) TETHERED DRONE ASSEMBLY

(71) Applicants: Pinakin Desai, Naperville, IL (US); Stephen M Faivre, Sycamore, IL (US); Peter Joseph Zerillo, Naperville, IL (US)

(72) Inventors: Pinakin Desai, Naperville, IL (US); Stephen M Faivre, Sycamore, IL (US); Peter Joseph Zerillo, Naperville, IL (US)

(21) Appl. No.: 15/141,709

(22) Filed: Apr. 28, 2016

Related U.S. Application Data
(60) Provisional application No. 62/154,158, filed on Apr. 29, 2015.
(60) Provisional application No. 62/167,836, filed on May 28, 2015.
(60) Provisional application No. 62/174,006, filed on Jun. 11, 2015.

(51) Int. Cl. B64D 1/16; B05B 13/00; B64C 39/02

(52) U.S. Cl. CPC B64D 1/16; B64C 39/022; B05B 13/005; B64C 2201/148; B64C 2201/141; B64C 2201/126; B64C 2201/127; B64C 2201/208; A01M 7/005

(57) ABSTRACT

A tethered drone assembly is provided. The tethered drone assembly may be a vehicle-based tethered drone assembly system or may be a free standing tethered drone assembly system. The tethered drone assembly has a plurality of drones each tethered by a cord. The tethered drones may hover in front of, behind or on either side of the vehicle so as to better survey the surrounding area of the vehicle. In some embodiments, a main product tank is used to supply liquids, foams, gases, powders, electrical power and/or electrical communication to the drones. A plurality of sensors located on the drones allows the drones to detect objects and environmental conditions in front of, behind or on either side of the moving vehicle in real-time and allow the vehicle to therein adjust its work accordingly. The drones may be controlled remotely by a user or may be automatically controlled by sensors.

### CROSS REFERENCE TO RELATED APPLICATIONS

The following application is based on U.S. provisional application Ser. No. 62/154,158 filed on Apr. 29, 2015; U.S. provisional application Ser. No. 62/167,836 filed on May 28, 2015; and U.S. provisional application Ser. No. 62/174,006 filed on Jun. 11, 2015 all currently co-pending, and claims the priority benefit of the '158, '836 and the '006 U.S. provisional applications; the entire contents of which are incorporated by reference.

### BACKGROUND OF THE INVENTION

A tethered drone assembly is provided. The tethered drone assembly may be a vehicle-based tethered drone assembly system or may be a free standing tethered drone assembly system. The tethered drone assembly system is especially suitable for use on moving vehicles, for example, a self-propelled conventional type vehicle operated by an operator or autonomous vehicle with no operator on board. The tethered drone assembly system may be used in, for example, the agricultural, construction, defense or other industries. The tethered drone assembly has a plurality of drones each tethered by a cord. In the embodiment utilizing a vehicle, the tethered drones may hover in front of, behind or on either side of the vehicle so as to better survey the surrounding area of the vehicle. In some embodiments, a main product tank is used to supply liquids, foams, gases, powders, electrical power and/or electrical communication to the plurality of drones. A plurality of sensors located on the drones allows the drones to detect objects and environmental conditions in front of, behind or on either side of the moving vehicle in real-time and to allow the vehicle to therein adjust its work accordingly. The drones may be controlled remotely by a user or may be automatically controlled by sensors. In an embodiment, the tethered drones may have downward or upward extending retractable tubes for delivering a substance.

Over the years, attempts have been made to incorporate drones into the agricultural industry. For example, U.S. Pat. No. 6,653,971 to Guice discloses a method and a system for detecting airborne plant material, such as mold spores and pollen, and flying insects and birds, and classifying them as to whether they are harmful to field crops, production animals or other assets within a protected volume or area. Lasers, radar, and other types of radiation may be used to illuminate at least a perimeter around such assets to be protected, with radiation returns detected and applied to a pattern classifier to determine whether the detected objects of interest are harmful, benign or beneficial. In the event the objects are determined to be harmful (pests), a variety of measures controllable via the radiation returns may be taken to eliminate the harmful objects, these measures including firing pulses of laser, microwave or other radiation of a sufficient intensity to at least incapacitate them, or mechanical measures such as controlled drone aircraft to macerate the pests with propellers or spray limited amounts of pesticide in the area of the pests.

U.S. Publication No.: 20140316614 to Newman discloses a data collection system having a first computer media for collecting image data, a second computer media for analyzing the image data and locating anomalies in the image data, a third computer media for linking particular image data to address data of the property where the anomaly is present and a fourth computer media for generating a list of pertinent properties having similar anomalies by address. The image data collected by an unmanned aerial vehicle or drone.

However, these patents and publications fail to describe a tethered drone assembly for use in, for example, the agricultural, construction, defense or other industries which is easy to use and efficient. Further, these patents and publications fail to describe a tethered drone assembly which has a plurality of drones tethered to a plurality of cords which provide electrical communication to the drones and which the drones provide real-time information on objects and environmental conditions surrounding the drones. The tethers may also be used for delivering materials to the surrounding environment.

### SUMMARY OF THE INVENTION

A tethered drone assembly is provided. The tethered drone assembly may be a vehicle-based tethered drone assembly system or may be a free standing tethered drone assembly system. The tethered drone assembly system is especially suitable for use on moving vehicles, for example, a self-propelled conventional type vehicle operated by an operator or autonomous vehicle with no operator on board. The tethered drone assembly system may be used in, for example, the agricultural, construction, defense or other industries. The tethered drone assembly has a plurality of drones each tethered by a cord. In the embodiment utilizing a vehicle, the tethered drones may hover in front of, behind or on either side of the vehicle so as to better survey the surrounding area of the vehicle. In some embodiments, a main product tank is used to supply liquids, foams, gases, powders, electrical power and/or electrical communication to the plurality of drones. A plurality of sensors located on the drones allows the drones to detect objects and environmental conditions in front of, behind or on either side of the moving vehicle in real-time and to allow the vehicle to therein adjust its work accordingly. The drones may be controlled remotely by a user or may be automatically controlled by sensors. In an embodiment, the tethered drones may have downward or upward extending retractable tubes for delivering a substance.

An advantage of the present tethered drone assembly is that the present tethered drone assembly may have a plurality of sensors on the drones which provide real-time information related to the ground surrounding the areas of the drones, near-by objects and environmental conditions surrounding the drones and further work performed around the drones so as to allow the operator of the drones to make adjustments in real-time,

Still further, an advantage of the present tethered drone assembly is that the present tethered drone assembly may allow a user to visually inspect for or for sensors to detect dangers, such as improvised explosive devices (LEDs) which may be located around the drones.

And another advantage of the present tethered drone assembly is that the present tethered drone assembly may be used to deliver liquids, foams, gases and/or powders to crops.

Yet another advantage of the present tethered drone assembly is that the present tethered drone assembly may have an extended, retractable delivery tube which al lows the liquids, foams, gases and/or powders to be delivered, for example, below a canopy of trees without the drone being caught or snagged by the canopy of trees.

Still another advantage of the present tethered drone assembly system is that the present tethered drone assembly may be outside of the control of the FAA due to all the drones being tethered.

And an advantage of the present tethered drone assembly is that the present tethered drone assembly may be controlled remotely by a user or may be controlled automatically by sensors and/or pre-programmed computer instructions.

Still another advantage of the present tethered drone assembly is that the present is tethered drone assembly may allow the plurality of drones to remain airborne almost in perpetuity as a result of the drones receiving a power supply through the tethers.

Yet another advantage of the present tethered drone assembly is that the present tethered drone assembly may have a tether support arm for partially directing and stabilizing the tethers of the tethered drone assembly.

Still another advantage of the present tethered drone assembly is that the present tethered drone assembly may have a band for partially directing one of the tethers of the tethering system.

Another advantage of the present tethered drone assembly is that the present tethered drone assembly may be used by, for example, painters, fire-fighters, farmers, construction workers, military personnel, etc.

Yet another advantage of the present tethered drone assembly is that the present tethered drone assembly may be used to deliver liquid building material, powdered building material, or a solid filament building material.

Yet another advantage of the present tethered drone assembly system is that the present tethered drone assembly may have a UV-laser secured to the underside of a drone which may be used to cure a powder or liquid resin located on the ground for 3D printing.

Another advantage of the present tethered drone assembly is that the present tethered drone assembly may allow the tethered drones to facilitate large scale additive manufacturing or “3D” printing.

And another advantage of the present tethered drone assembly is that the present tethered drone assembly may have a grasping device located on one of the drones for grasping and moving an object.

For a more complete understanding of the above listed features and advantages of the present tethered drone assembly reference should be made to the detailed description and the detailed drawings. Further, additional features and advantages of the invention are described in, and will be apparent from, the detailed description of the preferred embodiments.

### BRIEF DESCRIPTION OF THE DRAWINGS

FIG. 1 illustrates a perspective view of the tethered drone assembly system wherein a vehicle is not utilized.

FIG. 2A illustrates a perspective close-up of the airborne drones of the tethered drone assembly system.

FIG. 2B illustrates a perspective view of the tethered drone assembly system wherein a grasping mechanism is located on a retractable cord secured to the underside of a drone.

FIG. 3 illustrates a perspective view of the tethered drone assembly system wherein the system is secured to a vehicle.

FIG. 4 is a cross section of one of the tethers of the tethering system in one embodiment.

FIG. 5 illustrates a close-up of the bottom of one of the drones in an embodiment.

FIG. 6 illustrates an embodiment wherein a laser of a tethered drone is in the process of printing an object.

FIG. 7 illustrates an embodiment wherein a laser of a tethered drone is in the process of curing a resin.

FIG. 8 illustrates a perspective view of the vehicle-based tethered drone assembly having sensors and wherein the drones are located in front of, to the side and behind a moving vehicle.

FIG. 9a illustrates a perspective view of the tethered drone having the retractable delivery tube and spraying a liquid, foam, gas or powder below the canopy of trees.

FIG. 9b illustrates an embodiment wherein the tethered drone has a retractable delivery tube which extends upward, above the drone.

FIG. 10 illustrates a top view of the tethered drone assembly having the retractable delivery tube.

### DETAILED DESCRIPTION OF THE PREFERRED EMBODIMENTS

A tethered drone assembly is provided. The tethered drone assembly may be a vehicle-based tethered drone assembly system or may be a free standing tethered drone assembly system. The tethered drone assembly system is especially suitable for use on moving vehicles, for example, a self-propelled conventional type vehicle operated by an operator or autonomous vehicle with no operator on board. The tethered drone assembly system may be used in, for example, the agricultural, construction, defense or other industries. The tethered drone assembly has a plurality of drones each tethered by a cord. In the embodiment utilizing a vehicle, the tethered drones may hover in front of, behind or on either side of the vehicle so as to better survey the surrounding area of the vehicle. In some embodiments, a main product tank is used to supply liquids, foams, gases, powders, electrical power and/or electrical communication to the plurality of drones. A plurality of sensors located on the drones allows the drones to detect objects and environmental conditions in front of, behind or on either side of the moving vehicle in real-time and to allow the vehicle to therein adjust its work accordingly. The drones may be controlled remotely by a user or may be automatically controlled by sensors. In an embodiment, the tethered drones may have downward or upward extending retractable tubes for delivering a substance.

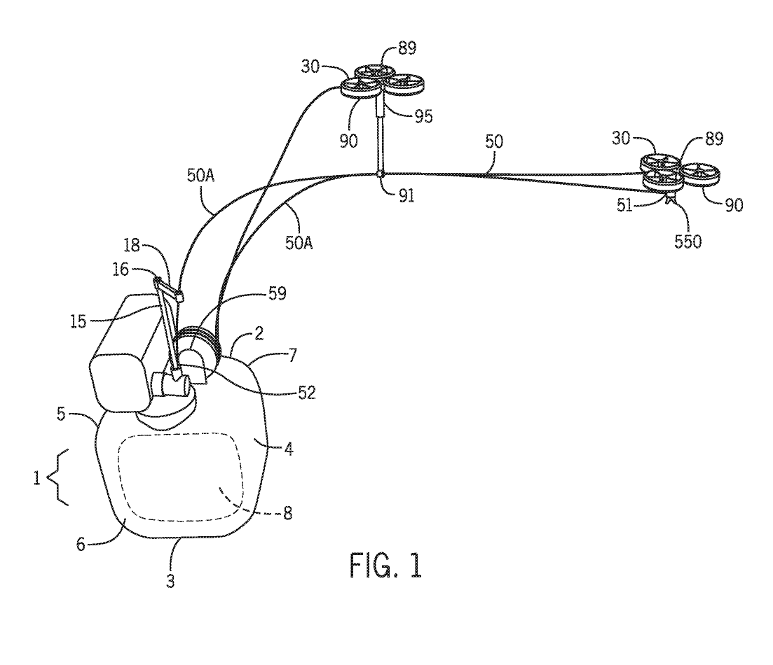

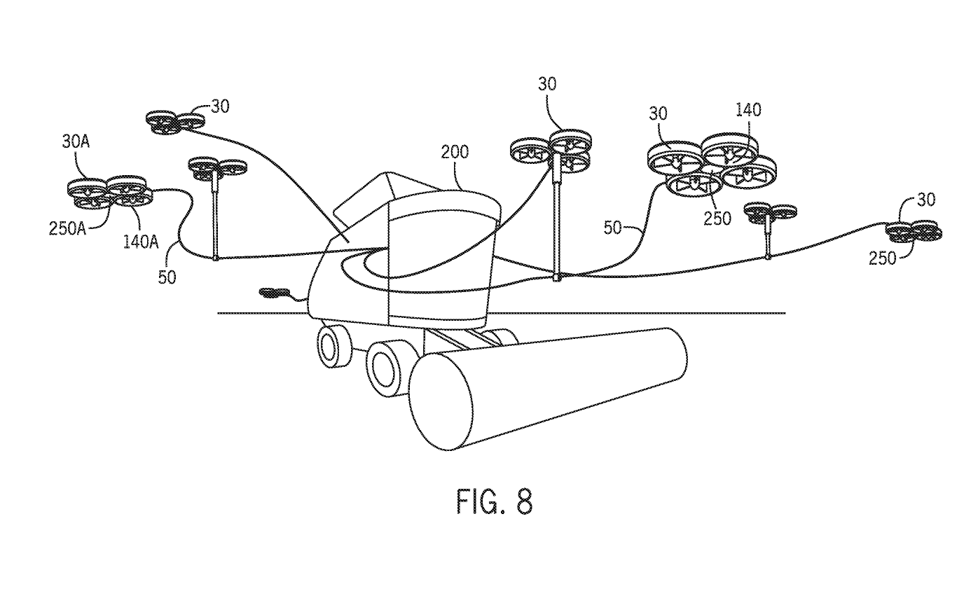

Referring first to FIG. 8, in an embodiment, a tethered drone assembly system is provided. FIG. 8 illustrates the tethered drone assembly system as a vehicle-based tethered drone assembly system, but it should be understood that the tethered drone assembly system of the present system by be land-based (as illustrated in FIG. 1).In the embodiment utilizing a vehicle, the vehicle-based tethered drone system may have a plurality of drones 30 secured to a vehicle 200. FIG. 8 illustrates the vehicle 200 as a farming tractor, however it should be understood that the vehicle 200 used in the system may be a vehicle used in the agricultural, construction, defense or other industries. In an embodiment, the plurality of drones 30 are secured to the vehicle 200 by a plurality of tethers 50. In an embodiment, the vehicle 200 may be autonomously controlled. In particular, the vehicle 200 may be control via sensors which detect the surrounding environment of the vehicle 200 and adjust accordingly. Further, the vehicle 200 may be remotely controlled by an operator in a remote location which monitors the movement of the vehicle 200 via, for example, a video camera located on the vehicle 200 which displays images on a monitor located remotely with the operator. Further, the vehicle 200 may be controlled by a human operator with the assistance of the detectors and monitors.

In an embodiment, at least one of the plurality of drones 30 may have a sensor 250. The sensor 250 may detect objects standing out from the environment such as, for example, ground conditions, water, movement of objects, differences in heat, the speed of moving objects, etc. Further, a camera 140 may be utilized to provide visual confirmation of objects detected by the sensors 250 of the drones 30. The sensors 250 and camera 140 may be especially suitable for detecting dangers such as, for example, improvised explosive devices (IEDs) which may be located in the vehicle's 200 immediate path. The sensors 250 may also be used to detect a hole in the ground which may render the vehicle 200 disabled during operation of the vehicle 200, such as, for example, during the harvesting of a crop.

As illustrated in FIG. 8, in an embodiment, a sensor 250A and a camera 140A may be located on a trailing drone 30A behind the vehicle 200. The trailing drone 30A may fly over the territory the vehicle 200 has already passed over. The trailing drone 30A may be especially suitable for detecting work already done, such as harvesting, planting, grading, tillage, etc. In particular, if the trailing drone 30A detects an issue with, for example, a patch of land for which the given tasks were not properly performed, the information may immediately be relayed to the operator who may address the issue by, for example, backing-up the vehicle 200 and re-performing the task before moving on. As a result, an operator (or software) may address an issue immediately before moving on and may therein save time. Further, in an embodiment, the drones 30 may be located on the side(s) of the vehicle 200 as well as, or in addition to, being located in front of or behind the vehicle 200.

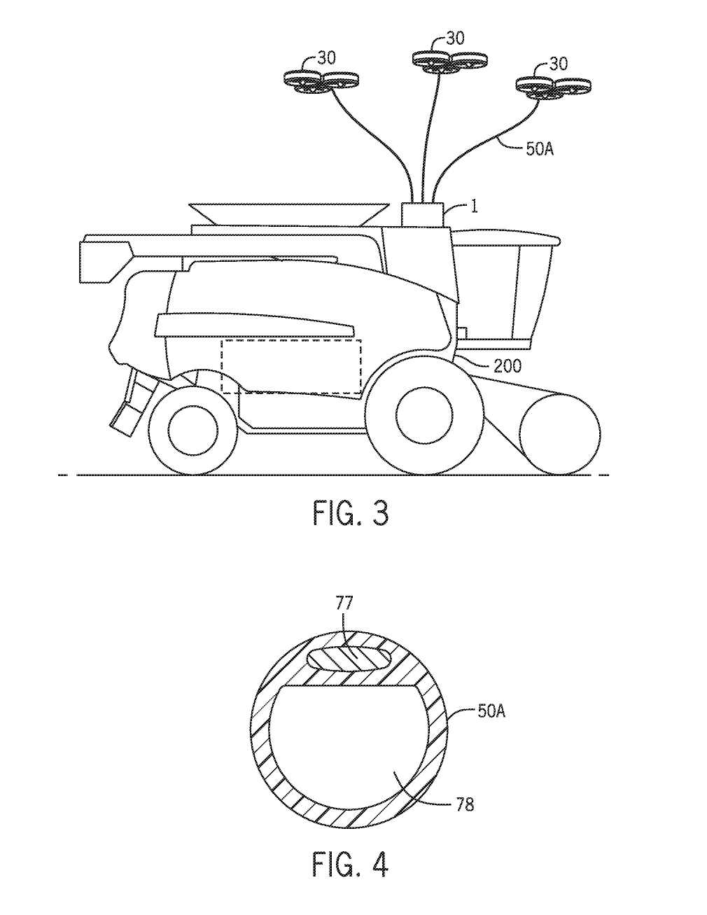

Referring now to FIGS. 1-3, in an embodiment, the plurality of drones 30 may be secured to a main product tank 1 (FIG. 1) which may act as a reservoir for storing product to be delivered through the plurality of drones 30. In an embodiment, the main product tank 1 may be located on the vehicle 200 (FIG. 3) or may be stationary and located on the ground (FIG. 1). The plurality of drones 30 may act as a lifting platform that may use propellers, jets or any other propulsion technology. A tethering system 50 may have a plurality of individual flexible tethers 50A wherein each individual tether 50A has a first end 51 and a second end 52. The tethering system 50 may connect the plurality of drones 30 directly to the vehicle 200 or to the product tank 1. In an embodiment wherein the product tank 1 is utilized, the product tank 1 may have a top 2, a bottom 3, a front 4, a back 5, a first side 6, a second side 7 and an interior 8. Preferably, the product tank 1 may be made of a generally sturdy material such as a non-corrosive metal.

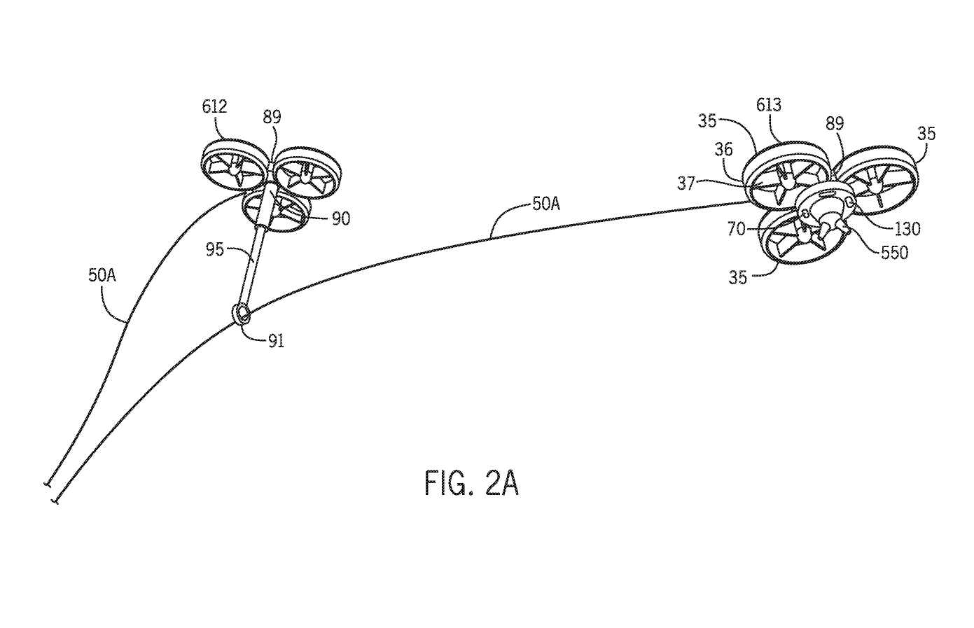

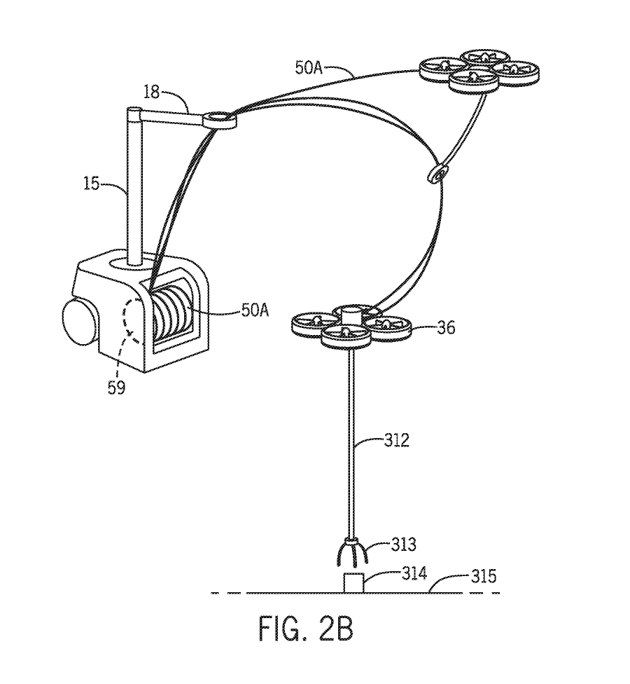

In an embodiment, a rotating reel 59 (FIGS. 1 and 2B) may be utilized to pull in or release the tether 50A of at least one of the drones 30. In particular, if an operator requires a drone 30 to be located farther away from the product tank 1, the operator may rotate the reel 59 to release more of the tether 50A. The more tether 50A which is wrapped around the rotating reel 59, the less power and energy the drone 30 needs to support the weight of that tether 50A. As a result, an operator typically only releases enough of the tether 50A as is necessary.

In an embodiment, a tether support arm 15 having a top 16 may be located on the top 2 of the product tank 1. The tether support arm 15 may be a generally cylindrical rod which extends upward from the product tank 1. A flexible band 18 may connect the top 16 of the of the tether support arm 15 to one of the tethers 50A of the tethering system 50. In particular, the band 18 may be connected near the second end 52 of a tether 50A of the tethering system 50. The tether support arm 15 and the band 18 may allow the individual tethers 50A to properly extend away from the product tank 1 in an upward manner and may further reduce tangling of the individual tethers 50A. In particular, the tether support arm 15 may be generally non-flexible so as to better direct the location of the tethers 50A.

Referring not to FIG. 2B, in an embodiment, the grasping mechanism 313 may be located on a retractable cord 312. The grasping mechanism 313 may allow the assembly system to grasp an object 314 located on the ground 315 so as to lift the object 314 and move the object 314 to a different location.

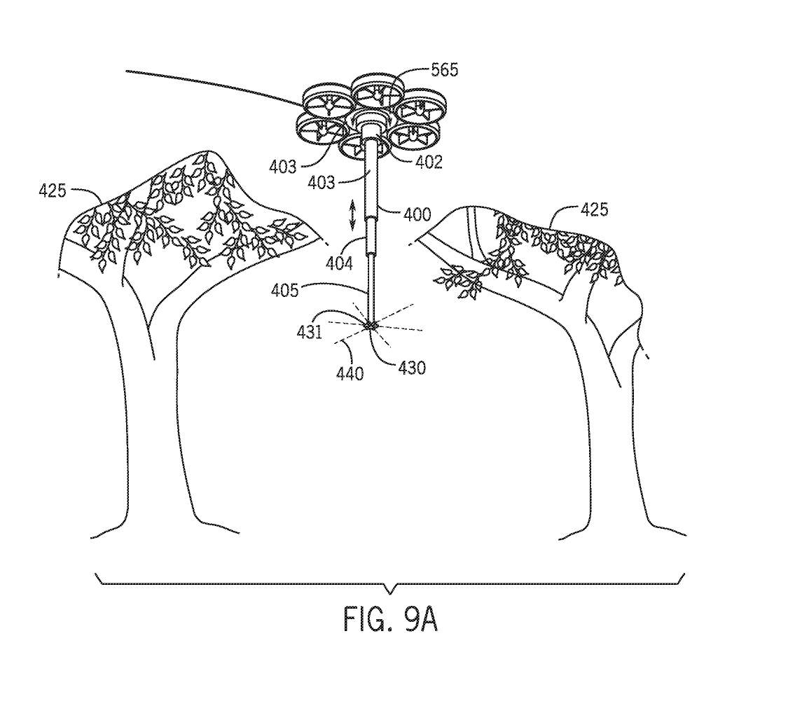

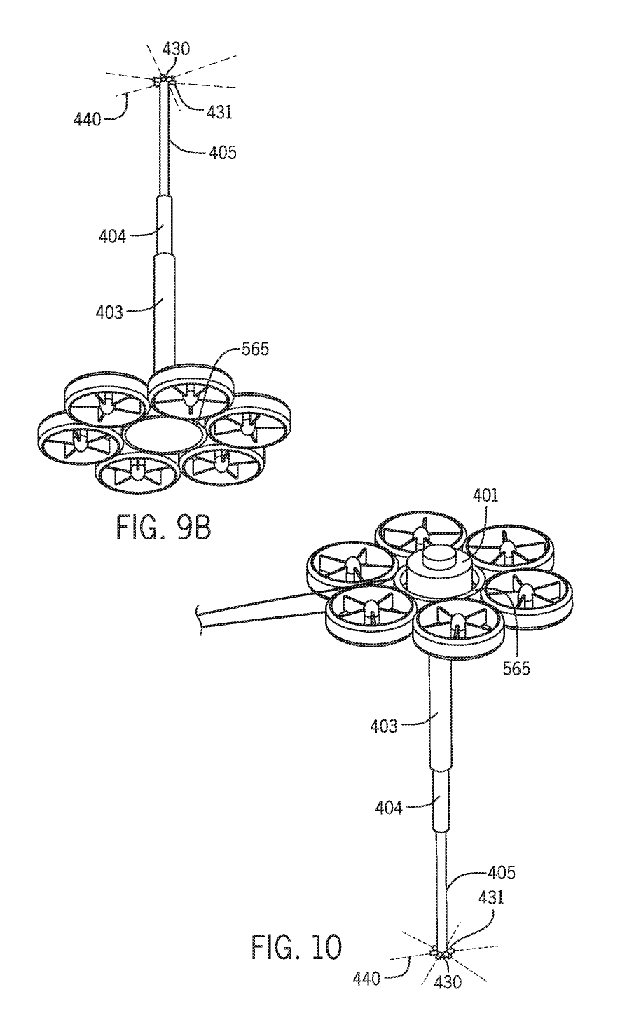

In an embodiment, the plurality of drones 30 may remain airborne almost in perpetuity as the plurality of drones 30 may receive a power supply from electrical wiring 77 (FIG. 4) located within the tethers 50A of the tether system 50. In addition to providing a power source to the plurality of drones 30, the electrical wiring 77 of the tether system 50 may provide the plurality of drones 30 with data and or electrical communications or instructions therein controlling the movement and other functions of the drones 30. In an alternative embodiment to FIG. 4, the electrical wiring 77 may simply be a separate wire secured in a bundle to the tethers 50A (embodiment not shown). In an embodiment, a substance (such as a liquid, foam, gas or powder 440 as illustrated in FIG. 9A) may be delivered from the main product tank 1, through a hollow main tube 78 of the tethers 50A, and then to the plurality of drones 30 through the tether system 50A.

In an embodiment, each of the plurality of drones 30 may have a top 89 and a bottom 90. The first end 51 of the tethers 50A may be supported by the drones 30, In an embodiment, if the tether 50A has a shorter length, as illustrated by drone 612. in FIG. 2, then that tether 50A may be entirely supported by the upward lift of that specific drone 612. However, if the tether 50A is longer (to therefore extend farther away from the vehicle 200 or product tank 1) then the additional weight of the longer tether 50A itself may he partially supported by another drone 30. In particular, drone 613 in FIG. 2A is partially supported by drone 612 in addition to its own lifting power. In this embodiment, the bottom 90 of one of the plurality of drones (612 in FIG. 2) may have a telescopically extending support pole 95. The telescopically extending support pole 95 may have a loop 91 which receives a portion of the tether 50A of a second drone 613 and therein supports and further partially directs the location of) the tether 50A of the second drone 613. In an alternative embodiment, the tethers 50A may be secured directly to the drones 30. FIG. 1 also illustrates one of the plurality of drones 30 utilizing the extended support pole 95 of a second drone 30 (the drone on the right).

In a preferred embodiment, the drones 30 may have a plurality of independent units 35 (FIG. 2A). Although FIGS. 1, 2A, 3 and 5 illustrate the drones 30 each having three independent units 35; a greater or fewer independent units 35 may be utilized, such as in FIGS. 2B, 9A, 9B and 10, Each independent unit 35 may have a generally cylindrical guard 36 surrounding a rotating blade 37 wherein the rotating blade 37 provides lift for the system.

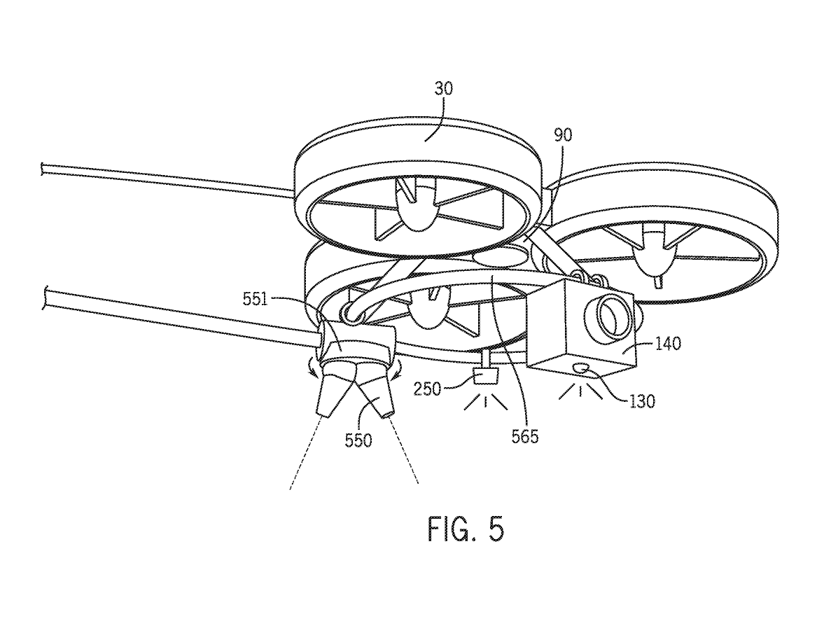

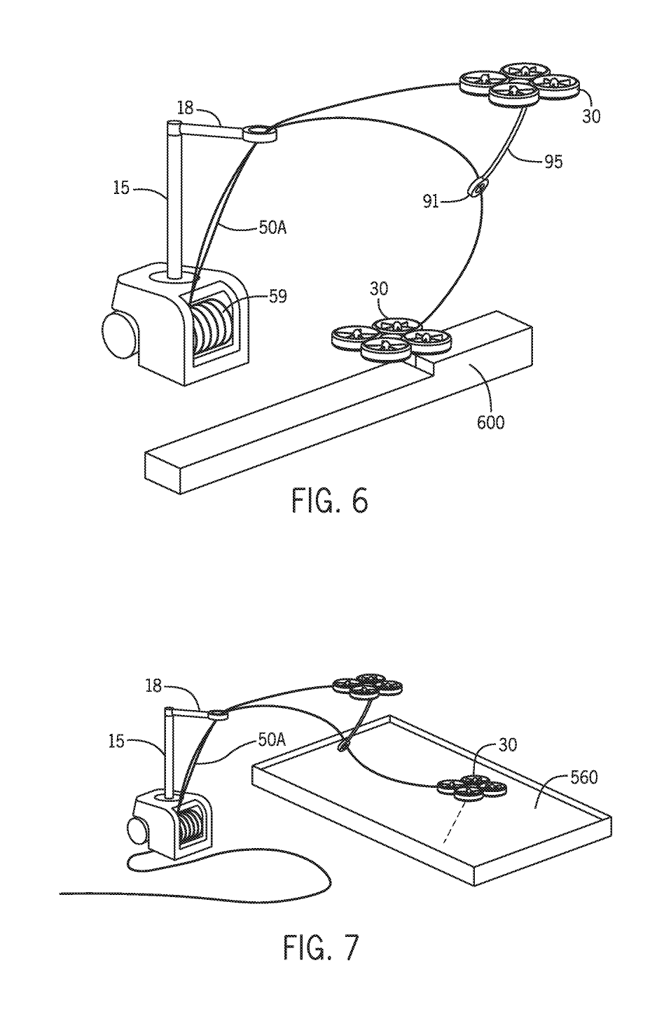

Referring now to FIGS. 5-7, in an embodiment, a laser 550 may be secured to the bottom 90 of the plurality of drones 30. In particular, the laser 550 may be secured on a rotating cylindrical base 551 which may allow the laser 550 to rotate and therein point in three hundred and sixty degrees. Further, the rotating cylindrical base 551 may therein itself be secured to a circular support ring 565 so as to allow a user to move the cylindrical base 551 for not only providing more accurate pointing of the laser 550 but also to allow the operator to more stabilize and balance the drone 30 by shifting the weight of the cylindrical base 551 and laser 550 and other attachments (such as a camera 140). In an embodiment, the laser 550 may be used, for example, to cure a resin 560 (FIG. 7) for 31) printing of an object 600 (FIG. 6). In an embodiment, the laser 550 is a UV-laser which is used to cure a powder, a granular or liquid resin 560 for 3D printing.

In an embodiment, the plurality of drones 30 may have a lighting system 130 and a camera 140 (FIG. 5) for better illuminating and recording the area located below the hovering drones 30. As a result, the device 1 may be utilized at night or in diminished lighting conditions. The camera 140 may allow the device 1 to accurately view an object from directly above the object. In an embodiment, the lighting system 130 and camera 140 may be secured to the support ring 565 for stabilizing and balance as well as aiming the lighting system 130 and camera 140.

In an embodiment, the plurality of drones 30 may have an opening valve 70 (FIG. 2A). The opening valve 70 may be located on the bottom 90 portion of the drones 30 and may be connected to the first end 51 of the tethers 50A. Once selectively opened, the opening valves 70 may deliver, for example, the liquid, foam, gas and/or powder 440 to a remote location. In particular, the opened valves 70 may allow a liquid, foam, gas or powder to flow from the main product tank 1 through a main tube 78 (FIG. 4) of the tether 50A. The material contained within the interior 8 of the main product tank 1 may be, for example, water to fight a fire or water crops, paint to paint the exterior of a building, pesticides for crops or other various liquids, foams, gases or powders 440 which need to be delivered remotely.

In an embodiment, the device 1 may have a GPS system secured to, for example, each of the individual of the plurality of drones 30. Securing a separate GPS system to each of the individual of the plurality of drones 30 may prevent the individual drones 30 from accidentally contacting each other while flying and may further prevent a specific drone 30 from double-covering the ground with, for example, an agricultural chemical, when a different drone 30 has already covered that ground.

The device 1 is especially suitable for sensing the ground conditions around the moving vehicle 200. For example, sensors 250 (FIGS. 5 and 8) on the plurality of drones 30 may detect the grading operation and/or the length of cut in a harvest. Further, the plurality of drones 30 may be especially suitable for sensing crop density and standing water surrounding the vehicle 200. Even further, the sensors 250 may be used to detect the type, quality and/or quantity of liquids, foams, gases or powders 440 discharged from the vehicle 200 for real-time analysis.

Referring now to FIGS. 9A, 9B and 10, in an embodiment, at least one of the plurality of drones 30 may have a retractable delivery tube 400 (which is different from the telescoping support pole 95 of FIG. 2A which is merely used for support). Although FIGS. 9A, 9B and 10 illustrate the retractable delivery tube 400 extending from a cluster of drones 30 it should be understood that a single drone 30 may have a retractable delivery tube 400 in an embodiment. The retractable delivery tube 400 may be generally cylindrical having at least a first hollow extension tube 403 and a second hollow extension tube 404 wherein the second extension tube 404 may telescopically be inserted at least partially within or extended away from the first extension tube 403. FIGS. 9A, 9B and 10 also illustrate an alternative embodiment with a third hollow extension tube 405 which telescopically extends partially within the second hollow delivery tube 404. An operator may selectively deliver the liquids, foams, gases or powders 440 through the retractable delivery tube 400.

The retractable delivery tube 400 may be especially suitable for delivering the liquids, foams, gases or powders 440 in an environment having a narrow opening. The narrow opening may be, for example, openings created in the canopy of trees 425, an opening in a roof of a building caused by an ongoing fire, etc. As a result, the tethered drone 30 may deliver, for example a pesticide to the ground beneath a canopy of trees 425 or may deliver water within the interior of a burning building without the drone 30 being at risk. An operator may retract the retractable delivery tube 400 to reduce air flow drag while the drone 30 is being transported in the air. In an embodiment, an operator (located remote from the drone) may further completely release the retractable delivery tube 400 from the drone 30 if the retractable delivery tube 400 becomes caught or tangled. As a result, the drone 30 may then be freed.

In an embodiment, the first extension tube 403 may be secured to a collar 402 of the drone 30 which is in turn secured to a generally circular support base located within, for example, the support ring 565 (FIG. 5). The generally circular support base and the collar 402 may allow the first extension tube 403 (and the second extension tube 404 and third extension tube 405) to rotate three hundred and sixty degrees.

Located at the distal end of the second extension tube 404 may be, for example, a sprinkler system 430 having a plurality of nozzles 431 which allow the liquids, foams, gases or powders 440 to be dispersed not only in a generally circular manner but also upward and/or downward with respect to the nozzles 431. As a result, the liquids, foams, gases or powders 440 may be delivered to a location below, for example, a canopy of trees 425 while the tethered drone 30 remains flying above the canopy 425 and therein safe from being tangled in the canopy 425. Further, when sprayed upward from the plurality of nozzles 431, the liquids, foams, gases or powders 440 may even spray the underside of the canopy 425.

Although embodiments of the invention are shown and described therein, it should be understood that various changes and modifications to the presently preferred embodiments will he apparent to those skilled in the art. Such changes and modifications may be made without departing from the spirit and scope of the invention and without diminishing its attendant advantages.

1) A tethered drone assembly for dispensing a liquid, a gas, or a powder comprising:
a reservoir tank having an interior wherein the reservoir is capable of storing the liquid, the gas or the power within the interior of the reservoir tank;
at least one drone having a top surface and a bottom surface wherein the drone has a motor capable of elevating the drone;
a flexible tether connecting the interior of the reservoir tank to the drone wherein the flexible tether has a hollow interior channel; and
a valve located on the drone wherein the valve is capable of selectively being opened to release the liquid, the gas or the powder passing from the interior of the reservoir, through the hollow interior channel of the flexible tether, then to the drone and finally out of the drone.

2) The tethered drone assembly for dispensing a liquid, a gas, or a powder of claim 1 further comprising:
a generally non-flexible tether support arm located on a top of the reservoir tank wherein the generally non-flexible tether support arm is capable of directing the location and movement of the flexible tether.

3) The tethered drone assembly for dispensing a liquid, a gas, or a powder of claim 2 further comprising:
a flexible band secured to the generally non-flexible tether support arm wherein the flexible band connects the non-flexible tether support arm to the flexible tether.

4) The tethered drone assembly for dispensing a liquid, a gas, or a powder of claim 1 wherein the tether has an electrical wire capable of supplying electrical power to the drone located within the interior tether adjacent to the hollow interior channel.

5) The tethered drone assembly for dispensing a liquid, a gas, or a powder of claim 1, further comprising:
a rotating wheel located on the reservoir tank wherein the rotating wheel is capable of pulling in or releasing a length of the tether.

6) The tethered drone assembly for dispensing a liquid, a gas, or a powder of claim 1 further comprising:
a second drone secured via a second tether wherein the second tether is secured to the reservoir tank and wherein the second done has an extending support pole having a ring and wherein the ring of the extending support pole partially supports the weight of a tether of an alternative drone.

7) The tethered drone assembly for dispensing a liquid, a gas, or a powder of claim 1 further comprising:
a retractable cord secured to the bottom surface of the drone wherein the retractable cord has a grasping claw capable of grasping and releasing an object and capable of lifting and moving the object.

8) The tethered drone assembly for dispensing a liquid, a gas, or a powder of claim 1 further comprising:
a circular support ring located on the bottom surface of the drone wherein the circular support right supports a camera, a light or a laser and wherein the camera, the light or the laser is mounted on a base and wherein the base may move along the circular support ring to balance the drone or to aim the camera, the light or the laser.

9) The tethered drone assembly for dispensing a liquid, a gas, or a powder of claim 1 wherein the laser of the drone cures a resin located on the ground.

10) The tethered drone assembly for dispensing a liquid, a gas, or a powder of claim 1 further comprising:
a hollow extension tube secured to the drone wherein the hollow extension tube extends downward from the drone and wherein the hollow extension tube is capable of spraying or delivering the liquid, the gas or the powder.

11) The tethered drone assembly for dispensing a liquid, a gas, or a powder of claim 10 wherein the hollow extension tube is telescopically retractable.

12) The tethered drone assembly for dispensing a liquid, a gas, or a powder of claim 1 further comprising:
a hollow extension tube secured to the drone wherein the hollow extension tube extends upward from the drone and wherein the hollow extension tube is capable of spraying or delivering the liquid, the gas or the powder.

13) The tethered drone assembly for dispensing a liquid, a gas, or a powder of claim 12 wherein the hollow extension tube is telescopically retractable.

14) The tethered drone assembly for dispensing a liquid, a gas, or a powder of claim 10 wherein the hollow extension tube may be selectively detached from the drone during flight if the hollow extension tube becomes tangled with an object.

15) A tethered drone assembly for dispensing a liquid, a gas, or a powder comprising:
a reservoir tank having an interior wherein the reservoir is capable of storing the liquid, the gas or the power within the interior of the reservoir tank;
wherein the reservoir tank is secured on a movable vehicle:
at least one drone having a top surface and a bottom surface wherein the drone has a motor capable of elevating the drone;
a flexible tether connecting the interior of the reservoir tank to the drone wherein the flexible tether has a hollow interior channel; and
a valve located on the drone wherein the valve is capable of selectively being opened to release the liquid, the gas or the powder passing from the interior of the reservoir, through the hollow interior channel of the flexible tether, then to the drone and finally out of the drone.

16) The tethered drone assembly for dispensing a liquid, a gas, or a powder of claim 15 wherein the vehicle is an autonomously controlled vehicle.

17) The tethered drone assembly for dispensing a liquid, a gas, or a powder of claim 15 further comprising:
a GPS system secured to the vehicle wherein the GPS system is capable of determining the location of the vehicle.
